(19) United States
(12) Patent Application Publication
(10) Pub. No.: US 2015/0189144 A1
(43) Pub. Date: Jul. 2, 2015

(54) INFORMATION PROCESSING APPARATUS AND METHOD THEREOF

(71) Applicant: CANON KABUSHIKI KAISHA, Tokyo (JP)

(72) Inventor: Hiroto Yoshii, Tokyo (JP)

(21) Appl. No.: 14/562,966

(22) Filed: Dec. 8, 2014

(30) Foreign Application Priority Data
Dec. 26, 2013 (JP) 2013-270130

(51) Int. Cl. H04N 5/235; G06T 7/40; H04N 13/02

(52) U.S. Cl. CPC H04N 5/2351; H04N 13/0207; G06T 7/40; G06T 2207/10004; G06T 2207/10028

(57) ABSTRACT

Luminance information of an object and information representing a three-dimensional shape of the object are acquired from an image of the object. Normal line information on a surface of the object is estimated from the information representing the three-dimensional shape, and the normal line information represents a normal direction of the surface of the object. A reflection characteristic of the object is estimated based on a correspondence between the luminance information and normal directions represented by the normal line information. It is evaluated whether a distribution of the normal directions represented by the normal line information is sufficient for estimation of the reflection characteristic.

### BACKGROUND OF THE INVENTION

1. Field of the Invention

The present invention relates to information processing of estimating the reflection characteristic of an object.

2. Description of the Related Art

There is known a technique of estimating the reflection characteristic of an object from data obtained by capturing the object and reproducing the “appearance” of the object under an arbitrary illumination condition. For example, Japanese Patent No. 3962588 discloses a method of expressing the reflection characteristic of an object as the approximate function of a reflection model, thereby reproducing the appearance of the object under an arbitrary illumination condition. This approximate function is calculated using a bi-directional reflectance distribution function (BRDF). As the reflection model, for example, a Gaussian reflection model, a Phong reflection model, a Torrance-Sparrow reflection model, or the like is used.

However, the above reflection characteristic estimation technique has the following problems.

First, to obtain the constant of the approximate function model, it is necessary to measure the surfaces of the object having various normal directions and luminance information at a plurality of points on the surfaces. To do this measurement, the object as the target (to be referred to as a “target object” hereinafter) is placed on a rotary table and captured while changing the relative positions of the target object and the camera or illumination. Hence, to estimate the reflection characteristic of the target object, a large-scale capturing apparatus many times larger than the target object is necessary. Additionally, since the procedure of rotating the rotary table, stopping it, and capturing the target object is repeated, a long time is needed to obtain the reflection characteristic of the target object.

Furthermore, the above-described method assumes obtaining surface normal directions of sufficient variety and corresponding luminance information (normal direction data) by rotating the target object using the rotary table. However, even when the target object is rotated using the rotary table, it may be impossible to obtain normal direction data of sufficient variety depending on the manner the target object is placed. If the variety of normal direction data is insufficient, the reliability of the constant estimation result in the approximate function model is low.

### SUMMARY OF THE INVENTION

In one aspect, an information processing apparatus comprising: an acquisition unit configured to acquire, from an image of an object, luminance information of the object and information representing a three-dimensional shape of the object; a first estimation unit configured to estimate normal line information on a surface of the object from the information representing the three-dimensional shape, the normal line information representing a normal direction of the surface of the object; a second estimation unit configured to estimate a reflection characteristic of the object based on a correspondence between the luminance information and normal directions represented by the normal line information; and an evaluation unit configured to evaluate whether a distribution of the normal directions represented by the normal line information is sufficient for estimation of the reflection characteristic.

According to the aspect, it is possible to easily and accurately estimate the reflection characteristic of an object.

Further features of the present invention will become apparent from the following description of exemplary embodiments with reference to the attached drawings.

### BRIEF DESCRIPTION OF THE DRAWINGS

FIG. 1 is a block diagram showing the functional arrangement of an information processing apparatus according to the first embodiment.

FIG. 2 is a block diagram showing the arrangement of an information processing apparatus that executes reflection characteristic estimation processing according to the present invention.

FIG. 3 is a view showing the capturing environment of a target object.

FIGS. 4A to 4C are graphs for explaining reflection characteristic estimation and normal direction distribution evaluation according to the first embodiment.

FIGS. 5A and 5B are views showing examples of dialogues that present a normal direction distribution evaluation result to a user.

FIG. 6 is a block diagram showing the functional arrangement of an information processing apparatus according to the second embodiment.

FIGS. 7A and 7B are graphs for explaining reflection characteristic estimation and normal direction distribution evaluation according to the second embodiment.

FIG. 8 is a block diagram showing the functional arrangement of an information processing apparatus according to the third embodiment.

FIGS. 9A and 9B are views showing examples of presentation of observed normal line information and a normal line lack region.

FIG. 10 is a block diagram showing the functional arrangement of an information processing apparatus according to the fourth embodiment.

FIG. 11 is a flowchart showing processing of determining and presenting a recommended orientation according to the fourth embodiment.

FIG. 12 is a view showing an example of orientation setting.

FIG. 13 is a view showing an example of presentation of a recommended orientation.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving measure of the present invention.

[Apparatus Arrangement]

The arrangement of an information processing apparatus that executes reflection characteristic estimation processing will be described before an explanation of reflection characteristic estimation processing according to an embodiment of the present invention.

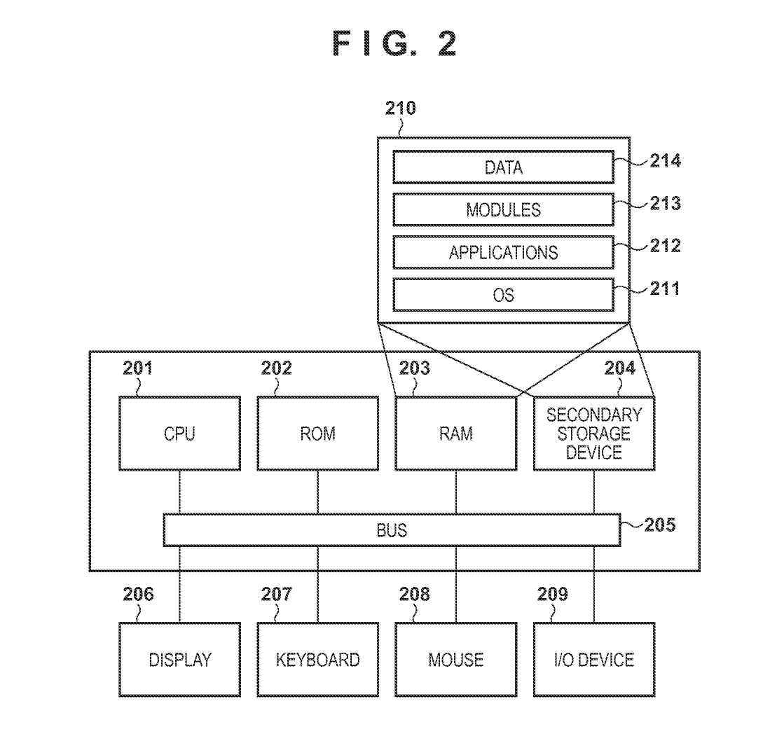

FIG. 2 is a block diagram showing the arrangement of an information processing apparatus that executes reflection characteristic estimation processing according to the present invention. Note that the arrangement shown in FIG. 2 is based on a personal computer that is widespread as a most typical information processing apparatus. Reflection characteristic estimation processing according to the present invention may be executed by an information processing apparatus of another form, for example, an embedded device, a digital camera, a tablet terminal, or the like.

Referring to FIG. 2, a microprocessor (CPU) 201 executes programs of various kinds of information processing including reflection characteristic estimation processing according to the embodiment, and controls all devices shown in FIG. 2. A read only memory (ROM) 202 is a nonvolatile memory, and holds a program necessary for the initial operation of the information processing apparatus. A random access memory (RAM) 203 and a secondary storage device 204 store programs 210 to be executed by the CPU 201, and the like. Note that the secondary storage device 204 stores an operating system (OS) 211, application programs 212, program modules 213, and the like as the programs 210, and also stores various kinds of data 214. These pieces of hardware 201 to 204 of the information processing apparatus exchange various kinds of information through a bus 205.

The information processing apparatus is connected to a display 206, a keyboard 207, a mouse 208, and an input/output (I/O) device 209 through the bus 205. The display 206 displays information such as a result of processing or report of progress of processing. The keyboard 207 and the mouse 208 are used to input user instructions. In particular, a pointing device such as the mouse 208 is used by the user to input a two- or three-dimensional positional relationship.

The I/O device 209 is used to receive new data or data to be registered. For example, when two-dimensional information is used as data, the I/O device 209 is constituted as a camera that captures a target object. When three-dimensional information is used as data, the I/O device 209 is constituted as a stereo camera formed from two cameras or as one pattern projecting device and at least one camera so that a random dot pattern projected by the pattern projecting device is captured by two cameras. Alternatively, a TOF (Time of Flight) sensor device may be used as the I/O device 209.

The I/O device 209 may output acquired information to another apparatus such as a robot control apparatus.

### First Embodiment

### Functional Arrangement

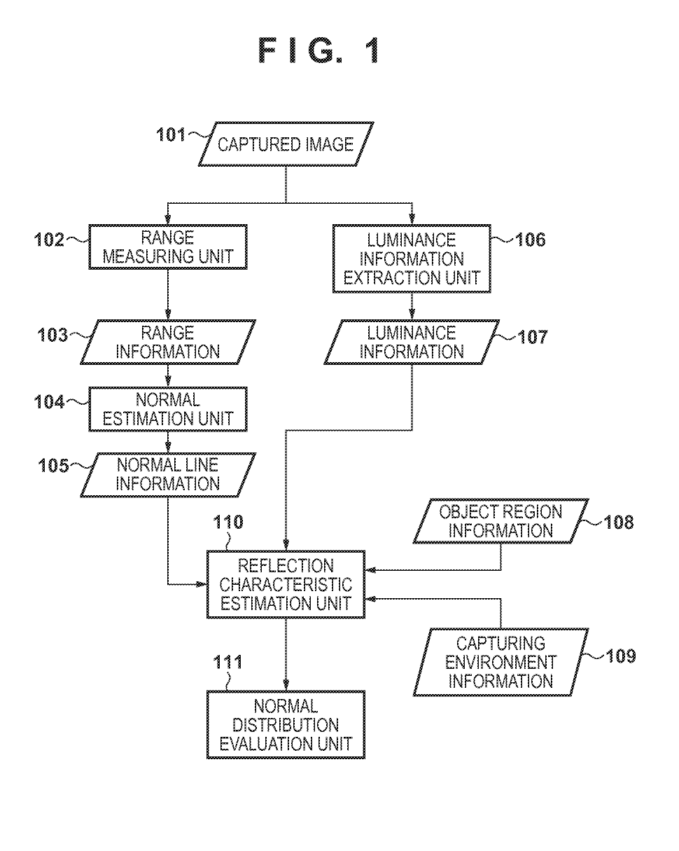

A functional arrangement for implementing reflection characteristic estimation processing according to the first embodiment of the present invention, which is implemented by the arrangement shown in FIG. 2, will be described below. FIG. 1 is a block diagram showing the functional arrangement of an information processing apparatus that executes reflection characteristic estimation processing according to the first embodiment.

The information processing apparatus first captures a target object using the I/O device 209 and obtains a captured image 101 of the target object. For example, if the I/O device 209 is a stereo camera, two images are obtained as the captured image 101 by one capturing process. If the I/O device 209 performs three-dimensional measurement using a slit light projecting method, a space encoding method, a phase shift method, or the like, N (N≧2) images are obtained as the captured image 101 by one capturing process.

The reflection characteristic estimation accurately changes depending on the arrangement of the target object when obtaining the captured image 101. It is therefore preferable to capture a plurality of target objects arranged in various orientations, in other words, a number of target objects arranged in a bulk state. Note that when only one target object is available, it is necessary to arrange the target object in various orientations and capture it each time. In this case as well, the reflection characteristic estimation processing according to the first embodiment is applicable, as a matter of course.

A range measuring unit 102 calculates range information 103 using the captured image 101. The range information 103 represents the range of the target object with respect to the capturing position, and is acquired as information representing the three-dimensional shape of the target object. Various methods are usable as the shape acquisition algorithm. The range is basically obtained using the principle of triangulation. That is, the range is obtained using a triangle (angle made by the two points and the measurement point) formed by two points on the space corresponding to the two devices (two cameras or one projecting device and one camera) included in the I/O device 209 and the three-dimensional measurement point of the target object. As another method, the range to the target object surface may be measured using the TOF method that measures the range from the time needed for a projected laser beam to travel through the space up to the target object and back.

Next, a normal estimation unit 104 calculates normal line information 105 representing the positions and directions of normals and the like on the target object surface using the range information 103. As an algorithm for calculating the normal line information 105, a method of obtaining local planes and normal vectors by plane fitting for a point of interest and a plurality of neighboring points (for example, eight neighboring points in the vertical, horizontal, and diagonal directions) is usable.

On the other hand, a luminance information extraction unit 106 extracts luminance information 107 from the captured image 101. For example, the luminance information 107 is obtained, from the captured image 101 obtained by capturing the target object under a predetermined illumination condition, based on luminance values at a plurality of points on the target object surface.

A reflection characteristic estimation unit 110 estimates a luminance distribution as the reflection characteristic of the target object by referring to capturing environment information 109 based on the normal line information 105 and the luminance information 107 obtained upon every capturing. At this time, only the data of the target object surface is preferably processed by referring to object region information 108 representing the target object existence region in the captured image 101.

As for the method of setting the object region information 108, in general, the user designates a region where the target object exists using a mouse or the like upon every capturing. Also usable is a method of acquiring the object region information 108 by defining, as the target object region, a region whose range based on the range information 103 is smaller than a predetermined threshold. There also exists a method of acquiring the object region information 108 by setting a background in a color completely different from that of the target object and causing the luminance information extraction unit 106 to extract a region different from the background color as the target object region. Note that luminance distribution estimation processing of the reflection characteristic estimation unit 110 will be described later in detail.

As for the reflection characteristic (luminance distribution) estimated by the reflection characteristic estimation unit 110, a normal distribution evaluation unit 111 evaluates whether the normal direction distribution is sufficient for the reflection characteristic estimation. If the normal direction distribution is insufficient for the reflection characteristic estimation, the user is notified that the target object should additionally be captured to obtain a sufficient normal direction distribution. In other words, the normal distribution evaluation unit 111 determines the necessity of additional capturing of the target object based on the normal direction distribution. Details will be described later.

[Reflection Characteristic Estimation]

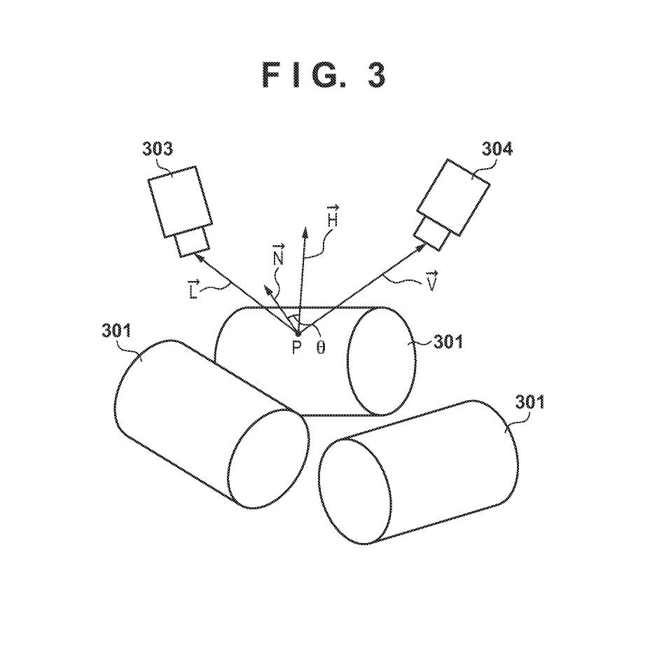

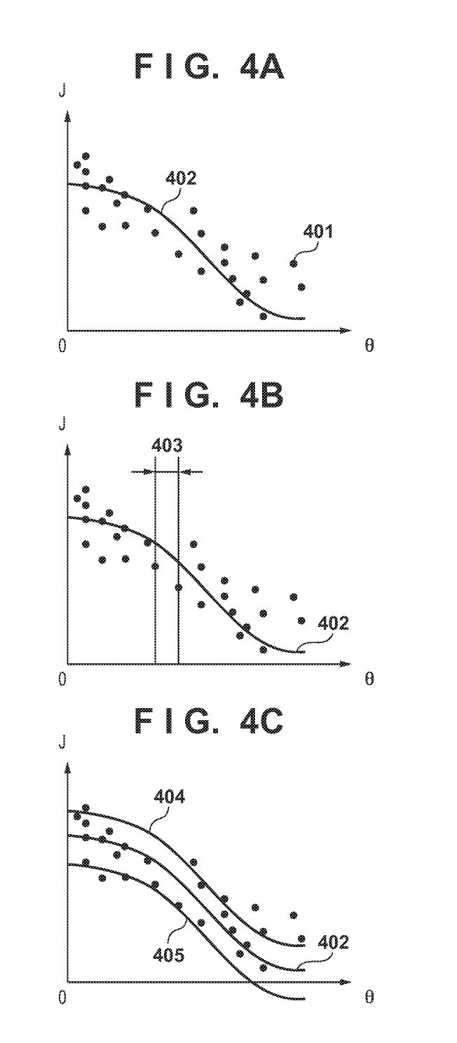

Processing of estimating the reflection characteristic (luminance distribution) of the target object by the reflection characteristic estimation unit 110 will be described below with reference to FIGS. 3 and 4A to 4C.

In the first embodiment, the light source in the capturing environment shown in FIG. 3 is assumed to be a single point source. Assuming that the surface of the target object causes diffuse reflection, the reflection characteristic of the target object is approximated by a luminance distribution model. Referring to FIG. 3, a point P on a target object 301 is set as the observation point of the target object surface. Note that three target objects 301 exist in the example shown in FIG. 3. These target objects are objects of the same type, that is, objects having the same shape and made of the same material. Light emitted by illumination 303 such as a projector is reflected at the point P on the target object 301, and a camera 304 receives the reflected light. The three-dimensional positions of the illumination 303 and the camera 304 are described in the capturing environment information 109.

A vector that connects the point P and the light source of the illumination 303 will be referred to as a “light source direction vector \vec{L}”, and a vector that connects the point P and the camera 304 will be referred to as a “camera direction vector \vec{V}” hereinafter. The point P reflects the light from the illumination 303, and the reflected light from that point reaches the camera 304. Hence, the positions and number of points P settable in the captured image 101 of one capturing process change depending on the shape and orientation of the target object 301.

An intermediate vector \vec{H} between the light source direction vector \vec{L} and the camera direction vector \vec{V} will be referred to as a “reflection central axis vector” hereinafter. The reflection central axis vector \vec{H} is a vector existing on a plane including the light source direction vector \vec{L} and the camera direction vector \vec{V} and makes equal angles with respect to the two vectors. A vector \vec{N} is the normal vector at the point P on the target object surface.

Let \vec{L}=(Lx, Ly, Lz) be the light source direction vector, and \vec{V}=(Vx, Vy, Vz) be the camera direction vector in the capturing environment shown in FIG. 3. The reflection central axis vector \vec{H}=(Hx, Hy, Hz) is given by

H=(\vec{L}+\vec{V})/∥\vec{L}+\vec{V}∥ (1)

On the other hand, let \vec{N}=(Nx, Ny, Nz) be the normal vector, and θ be the angle made by the reflection central axis vector \vec{H} and the normal vector \vec{N}. θ is given by

θ=cos⁻¹{\vec{H}·\vec{N}/(∥\vec{H}∥∥\vec{N}∥)} (2)

Note that the reflection characteristic estimation unit 110 can acquire the light source direction vector \vec{L} and the camera direction vector \vec{V} at the point P of the target object 301 from the three-dimensional positions of the illumination 303 and the camera 304 described in the capturing environment information 109. The normal vector \vec{N} is acquired as the normal line information 105.

When the reflection characteristic of the target object 301 is approximated by a Gaussian function, a luminance value J acquired as the luminance information 107 at the point P is expressed using a Gaussian function as a function of θ given by

J(θ)=C·exp(−θ²/m) (3)

where C and m are luminance distribution parameters respectively representing the intensity of the entire luminance distribution and the spread of the luminance distribution. In the first embodiment, the luminance distribution model is approximated by estimating the parameters.

FIG. 4A shows an example of an observation point distribution that plots sets of luminance values J and θ observed for a plurality of points of interest. Referring to FIG. 4A, a point 401 represents observation point data, and a curve 402 represents the relationship between J and θ given by equation (3), that is, the approximate expression of the luminance distribution model. In the first embodiment, since the surfaces of the target objects 301 are made of the same material, the observation points that plot the observation point data 401 in FIG. 4A are points on the surfaces of the target objects 301 captured at the time of observation.

Since θ is the function of the normal vector \vec{N}, as is apparent from equation (2), and θ axis shown in FIG. 4A can be regarded as the same as the normal direction axis.

Note that when the target object 301 has a plurality of types of reflection characteristics, the object region information 108 is set for each reflection characteristic, and plotting of the observation point data 401 and estimation of the approximate curve as shown in FIG. 4A are performed for each reflection characteristic type. In this case as well, when the capturing count is increased, the number of observation point data 401 increases, and the estimation accuracy of the approximate curve 402 rises. Note that since the observation point data 401 include data supposed to be noise, data assumed to be noise, for example, data largely deviated from the average value of the observation point data 401 is deleted in some cases.

The reflection characteristic estimation unit 110 estimates, from the observation point data 401, the luminance distribution parameters C and m in the Gaussian function represented by equation (3) as the parameters of the luminance distribution model approximate expression. Ideally, all observation point data 401 are located on the approximate curve 402 representing the Gaussian function of equation (3). In fact, the observation point data 401 include errors (variations) to some extent, as shown in FIG. 4A. To estimate the luminance distribution parameters C and m of equation (3) from the observation point data 401 including errors, a maximum likelihood fitting algorithm is used. More specifically, an error function E is defined as the square sum of the difference between the estimated value and the observed value by

E=Σⱼ{J(θⱼ)−Jⱼ}² (4)

where j is the number to identify observation point data, and the Σ operation represents the total sum for j observation point data.

Maximum likelihood fitting is considered as the minimization problem of the error function E. The error function E is a downward-convex quadratic function concerning the parameter C. For this reason, when

∂E/∂C=0 (5)

is solved, the update expression of the parameter C is obtained as

C=ΣⱼJⱼexp(−θⱼ²/m)/Σⱼexp(−2θⱼ²/m) (6)

As for the parameter m, γ=1/m is set to simplify calculation and solved as the optimization problem of γ. Since the error function E is not a convex function concerning γ, the error function E is decomposed for each data as

Eⱼ={J(θⱼ)−Jⱼ} (7)

and solved for each data.

When equation (7) is solved by the steepest descent method, the serial update expression is given by

$$\begin{matrix}{γ}^{new} = {γ}^{old} - η \cdot \partial {E}_{j} / \partial γ \\ = {γ}^{old} - η [ - 2 C {θ}_{j}^{2} exp ( - {γθ}_{j}^{2} ) \{ C {θ}_{j}^{2} exp ( - {γθ}_{j}^{2} ) - {J}_{j} \} ]\end{matrix} \qquad ( 8 )$$

This is called the Robbins-Monro procedure. Note that a coefficient η in equation (8) is a constant defined by a positive value and generally given as the reciprocal of the number of observation data.

The method of estimating the luminance distribution parameters C and m in a case where the luminance distribution model is approximated by a Gaussian function when the target object surface causes diffuse reflection has been described above. However, mirror reflection components cannot be expressed by approximation using the Gaussian function. When considering the mirror reflection components on the target object surface, a Torrance-Sparrow luminance distribution model is applied, which is given by

J(θ,α,β)=K_{d} cos α+Kₛ(1/cos β)exp(−θ²/m) (9)

where K_{d}, Kₛ, and m are the luminance distribution parameters of this model.

When this model is applied to FIG. 3, θ is the angle made by the normal vector \vec{N} and the reflection central axis vector \vec{H} on the surface of the target object 301, like θ of equation (2). In addition, α is the angle made by the normal vector \vec{N} and the light source direction vector \vec{L}, and β is the angle made by the normal vector \vec{N} and the camera direction vector \vec{V}, which are respectively given by

α=cos⁻¹ {\vec{L}·\vec{N}/(∥\vec{L}∥∥\vec{N}∥)} (10)

β=cos⁻¹ {\vec{V}·\vec{N}/(∥\vec{V}∥∥\vec{N}∥)} (11)

Angles αⱼ and βⱼ in equation (9) corresponding to each observation pixel j can be obtained by equations (10) and (11). The observation distribution of luminance values Jⱼ corresponding to θⱼ, αⱼ, and βⱼ can thus be obtained. When the model of equation (9) is applied to the observation distribution by maximum likelihood fitting, the estimation model of the surface luminance distribution of the target object 301 can be obtained.

[Normal Direction Distribution Evaluation]

When the above-described reflection characteristic estimation method and a special device such as a rotary table are used, sufficient observation data can be obtained, and in particular, sufficient variety can be ensured concerning the normal directions of observation points. However, in the observation state as shown in FIG. 3 assumed in the present invention, one or more target objects 301 are only arranged without using a device such as a rotary table. Hence, sufficient variety cannot be always obtained concerning the normal directions of observation points.

For example, the observation point data 401 plotted in FIG. 4A may localize around “certain values θ”. If the values θ localize without variety of normal directions of observation points, the parameters of the luminance distribution model cannot appropriately be estimated, and the appearance of the target object under an arbitrary illumination condition is incorrectly reproduced. The normal distribution evaluation unit 111 according to the first embodiment evaluates the normal direction distribution of observation points, thereby solving this problem.

Processing of evaluating the normal direction distribution of observation points by the normal distribution evaluation unit 111 will be described below with reference to FIGS. 4B and 4C.

FIG. 4B shows a distance 403 (to be referred to as a distance between adjacent points hereinafter) between adjacent observation points for the variable θ that determines the luminance value J of equation (3) in the observation point distribution shown in FIG. 4A. The distance 403 between adjacent points corresponds to the distance (that is, angle) between normal directions and serves as the evaluation target of the normal distribution evaluation unit 111. Note that in the Torrance-Sparrow model described by equation (9), the three variables θ, α, and β determine the luminance value J, and the distance 403 between adjacent points for each variable is the evaluation target. A maximum allowable value and a minimum allowable value of θ may be preset. For the observation point where θ is maximized out of the observation point data, the distance from the maximum allowable value may be evaluated as the distance 403 between adjacent points. For the observation point where θ is minimized, the distance from the minimum allowable value may be evaluated as the distance 403 between adjacent points.

As the evaluation algorithm of the normal distribution evaluation unit 111, for example, it is determined whether the maximum value of all distances 403 between adjacent points is equal to or smaller than a predetermined threshold (for example, 10°). As an evaluation result, the normal distribution evaluation unit 111 outputs one of “OK” representing that the normal direction distribution is sufficient, and additional capturing of the target object 301 is unnecessary and “NG” representing that the normal direction distribution is insufficient, and additional capturing of the target object 301 is necessary.

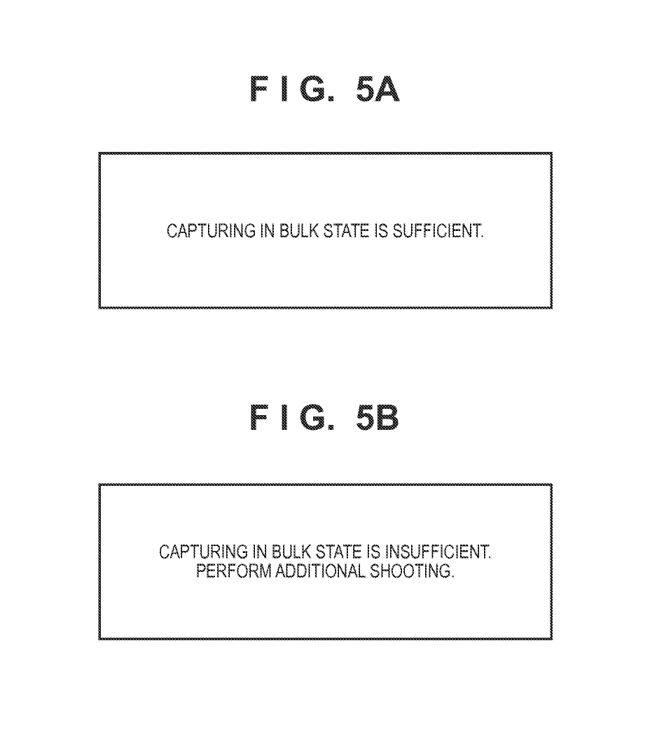

When the evaluation result is OK, the normal distribution evaluation unit 111 displays a dialogue representing that sufficient captured data has been obtained, as shown in, for example, FIG. 5A, thereby notifying the user that capturing is not necessary any more. On the other hand, when the evaluation result is NG, the normal distribution evaluation unit 111 displays a dialogue representing that captured data is still insufficient, and additional capturing of the target object 301 is necessary, as shown in, for example, FIG. 5B, thereby prompting the user to do additional capturing. Note that since the additional capturing aims at making up for a lack of normal line information, preferably, the user knows or is notified at the time of additional capturing that the orientation (arrangement) of the target object should be changed.

Note that an example in which the determination result of sufficiency of normal direction distribution is displayed as a dialogue has been described here. However, not display but any other method such as lighting of a lamp or a beep sound may be used, as a matter of course, if the determination result can be notified.

As an example in which the evaluation result is NG, a situation will be considered in which the target object 301 has two principal planes, and the values θ localize in two places (values) and form two groups. If the distance between the two groups is equal to or larger than a predetermined threshold, the evaluation result of the normal direction distribution is NG. In this case, when the arrangement of the target object is changed, and additional capturing is performed, observation point data between the two groups increase, and the maximum value of the distances 403 between adjacent points shown in FIG. 4B becomes small. As a result, if the maximum value of the distances 403 between adjacent points becomes smaller than the threshold, the dialogue shown in FIG. 5B is displayed.

Another method of evaluating the normal direction distribution of observation points by the normal distribution evaluation unit 111 will be described with reference to FIG. 4C. FIG. 4C shows curves 404 and 405 indicating the tolerance for errors with respect to the approximate curve 402 in the observation point distribution shown in FIG. 4A. When the number of observation point data within the tolerance is equal to or larger than a predetermined number (threshold), the evaluation result is OK. In other words, the number of observation points at which the error E of observation point data from the luminance distribution model, which is calculated by equation (7), falls within the tolerance for errors is counted. When the counted number is equal to or larger than a predetermined number (threshold), the evaluation result is OK.

Note that when the values θ localize, the estimation error of the luminance distribution model tends to be large. Hence, the evaluation can effectively be done by counting observation point data existing within the tolerance for errors, as described here. However, the number of observation point data existing within the tolerance for errors may be large even when the values θ localize. To cope with this case, for example, the range of values θ is divided into N sections, and it is determined in each section whether the number of observation point data existing within the tolerance for errors is equal to or larger than a predetermined number. Note that in the Torrance-Sparrow model described by equation (9), the three variables θ, α, and β determine the luminance value J. In this case, the space formed by the three variables is divided into N spaces, or division to N sections is performed for each variable.

Note that in the first embodiment, an example has been described in which the reflection characteristic estimation unit 110 approximates the luminance distribution model, and after that, the normal distribution evaluation unit 111 evaluates the normal direction distribution. However, the processing order may be reversed. That is, when an observation point distribution as shown in FIG. 4A is obtained, the normal direction distribution may be evaluated. When the evaluation result is OK, the approximate curve 402 of the luminance distribution model may be determined.

As described above, when estimating the parameters of the luminance distribution model that approximates the reflection characteristic of the target object, it is determined whether the observation point data has a variety sufficient for the estimation. If the variety is short, the user is prompted to do additional capturing of the object. This makes it possible to easily and accurately estimate the reflection characteristic of the target object.

Note that in the first embodiment, the reliability of the range information 103, the luminance information 107, and the normal line information 105 is evaluated. If necessary, immediately preceding capturing is canceled, and the capturing itself is not redone. Inclusion of unreliable observation data is assumed, as a matter of course. However, reflection characteristic estimation processing is implemented by prohibiting use of unreliable observation data.

### Second Embodiment

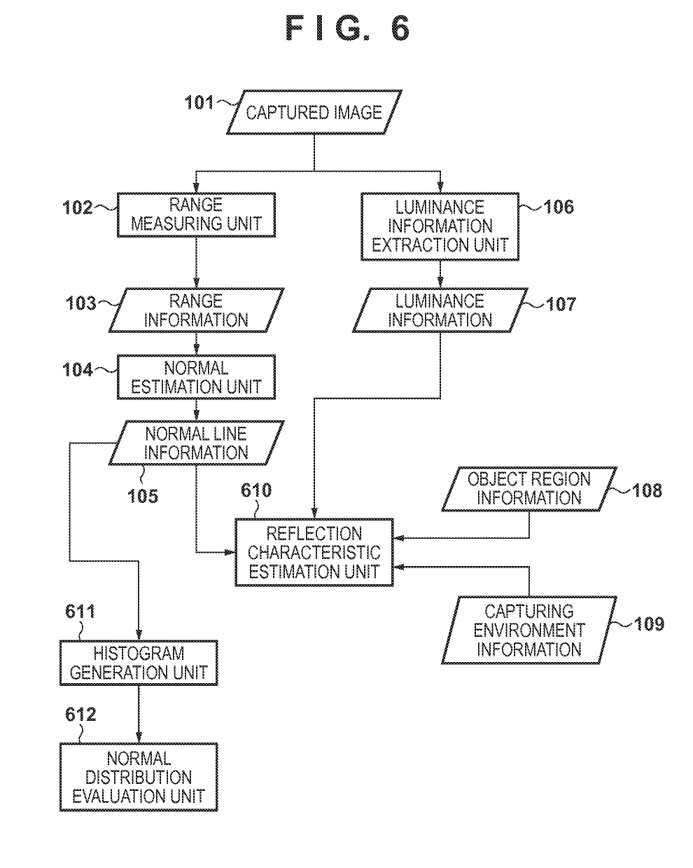

A functional arrangement for implementing reflection characteristic estimation processing according to the second embodiment of the present invention, which is implemented by the arrangement shown in FIG. 2, will be described below. FIG. 6 is a block diagram showing the functional arrangement of an information processing apparatus that executes reflection characteristic estimation processing according to the second embodiment. Note that the same reference numerals as in FIG. 1 described above denote the same parts in FIG. 6, and a description thereof will be omitted.

In the first embodiment, an example has been described in which equations (3) and (9) that describe a luminance distribution model are set, and parameters included in the equations are estimated using actual observation data. The method of estimating the parameters of a relational expression assuming that data applies to the relational expression is called an estimation method using a parametric model. On the other hand, a method of estimating a true reflection characteristic from observation data without particularly assuming a relational expression is called an estimation method using a nonparametric model. In the second embodiment, the reflection characteristic estimation using a nonparametric model will be explained.

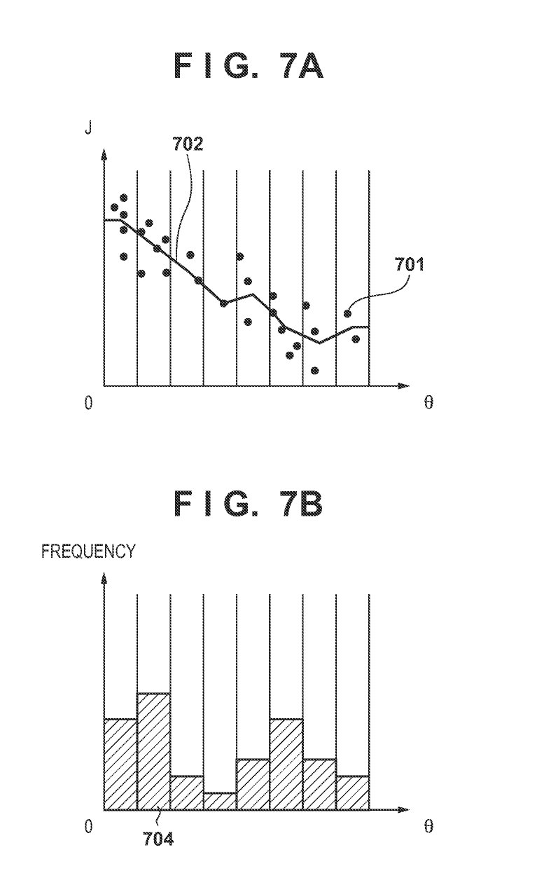

Referring to FIG. 6, a reflection characteristic estimation unit 610, a histogram generation unit 611, and a normal distribution evaluation unit 612 are different from the first embodiment. The operations of these units will be described with reference to FIGS. 7A and 7B.

[Reflection Characteristic Estimation]

Processing of estimating the reflection characteristic (luminance distribution) of a target object surface by the reflection characteristic estimation unit 610 will be described first with reference to FIG. 7A. FIG. 7A is a graph showing the distribution of observation point data 701, like FIG. 4A. A curve 702 is an estimation curve representing the relationship between a luminance J and a variable θ estimated using a luminance distribution model in the second embodiment.

A method of generating the estimation curve 702 will be described below. First, as shown in FIG. 7A, the domain of the variable θ that determines the luminance J is divided into a plurality of sections. In each section, the average value of J of the observation point data 701 after noise data removal is obtained. In each section, a point that has the section median of θ and the average value of J in the section is defined as the representative point of the section. A polygonal line formed by connecting the representative points of the sections is the estimation curve 702 representing the relationship between the luminance J and the variable θ.

Note that as the method of extrapolating the estimation curve 702 from the section median of θ to an end in the sections where θ is maximized or minimized, the extrapolation can be performed assuming that the average value of J continues in both sections, as shown in FIG. 7A. The extrapolation may be done under a condition that the luminance J takes a predetermined minimum or maximum value in correspondence with the maximum or minimum value of θ. An example in which the representative point is determined based on the section median of θ has been described here.

However, the representative point may be determined based on the value at an end of each section, that is, the section maximum or minimum value of θ. A nonparametric estimation method evenly using the average value of the luminances J as the representative value in each section is also usable. This estimation method is advantageous because it can easily be applied even when the number of variables to determine the luminance J is two or more. However, since discontinuous points concerning the luminance J are generated at the boundaries of the sections, a luminance difference may occur in a place where it cannot exist by nature upon reproducing the “appearance” of the target object. To avoid this, the estimation curve 702 (or estimation surface) of the luminance J needs to be smoothed at the boundaries of the sections.

[Normal Direction Distribution Evaluation]

Processing of evaluating the normal direction distribution of observation points by the histogram generation unit 611 and the normal distribution evaluation unit 612 will be described below.

Division of the domain of the variable θ in FIG. 7B is the same as the division in FIG. 7A. The histogram generation unit 611 generates a histogram 704 of observation point data in each section of θ. As the simplest algorithm, the number of observation point data is counted in each section of θ. Only observation point data that fall within average value±standard deviation of the luminances J may be counted in each section. At this time, if there is no observation data, the count value of the bin in the histogram is set to 0. Alternatively, only observation point data that fall within a predetermined tolerance including the median of the luminances J in each section may be counted.

The histogram concerning θ is thus generated, as shown in FIG. 7B. As is apparent from equation (2), θ is the function of a normal vector N. Hence, the histogram by division of θ equals the histogram by division in the normal direction. This histogram will be referred to as a “normal histogram” hereinafter.

In the light reflection characteristic estimation method using a nonparametric model, observation point data in a somewhat large number are necessary in each section. The normal distribution evaluation unit 612 presets the lower limit (threshold) of the count value (number of observation point data) of the histogram 704. If the count value is equal to or larger than the lower limit in all sections, the evaluation result is OK, and a dialogue as shown in FIG. 5A is displayed, as in the first embodiment. On the other hand, if the count value is smaller than the lower limit in at least one section, the evaluation result is NG, and a dialogue as shown in FIG. 5B is displayed to prompt the user to do additional capturing of the target object.

The reflection characteristic of the target object can thus be estimated using a nonparametric model.

Note that the histogram generation unit 611 and the normal distribution evaluation unit 612 described above are applicable to the parametric model of the first embodiment as well. In this case, the variable space (θ) that determines the luminance J is divided. A normal histogram is generated by counting observation data meeting a condition included in each section. It is determined whether the count value is equal to or larger than a predetermined lower limit (threshold) in all sections, thereby determining whether the normal direction distribution is sufficient.

### Third Embodiment

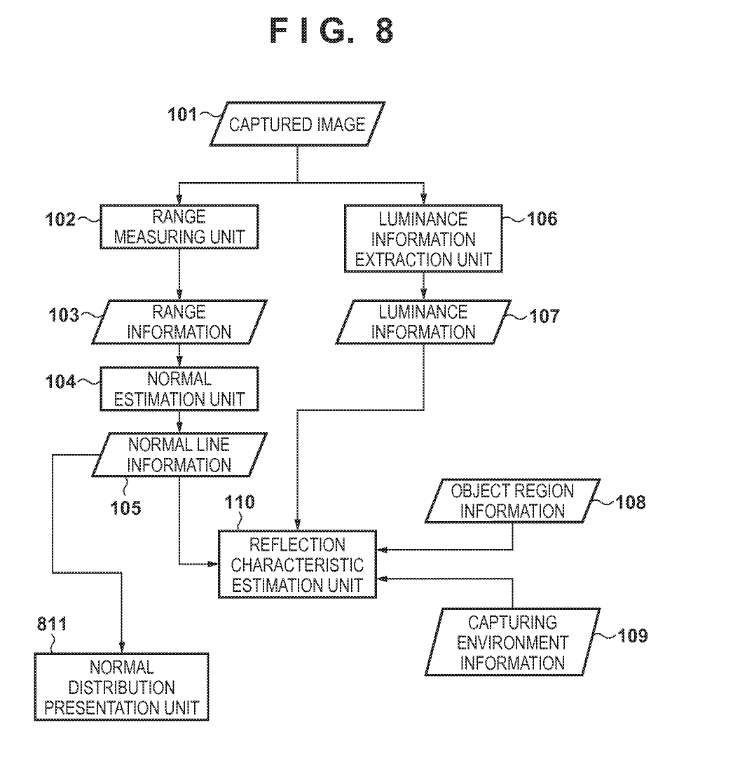

A functional arrangement for implementing reflection characteristic estimation processing according to the third embodiment of the present invention, which is implemented by the arrangement shown in FIG. 2, will be described below. FIG. 8 is a block diagram showing the functional arrangement of an information processing apparatus that executes reflection characteristic estimation processing according to the third embodiment. Note that the same reference numerals as in FIG. 1 described above denote the same parts in FIG. 8, and a description thereof will be omitted.

In the first and second embodiments, an example has been described in which it is determined whether the normal line information 105 obtained from the captured image 101 is sufficient for estimating the surface reflection characteristic of the target object, and if insufficient, the user is prompted to perform additional capturing of the target object. In the third embodiment, a method of proposing an effective target object arrangement method at the time of additional capturing will be described.

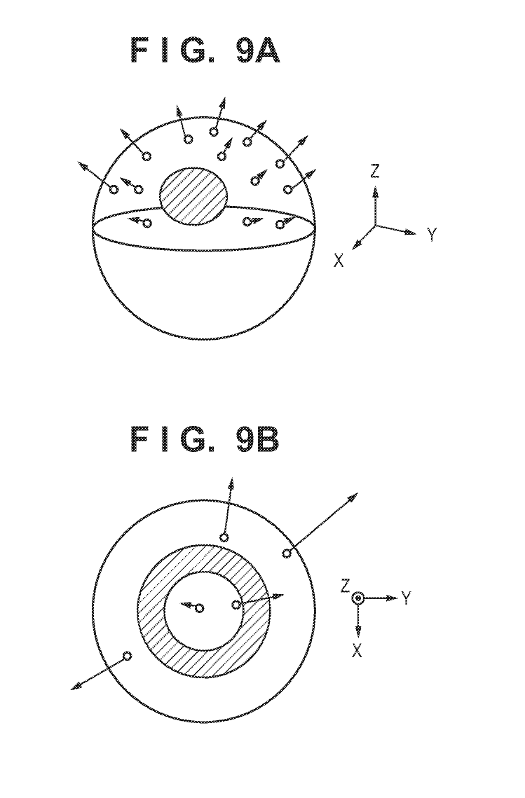

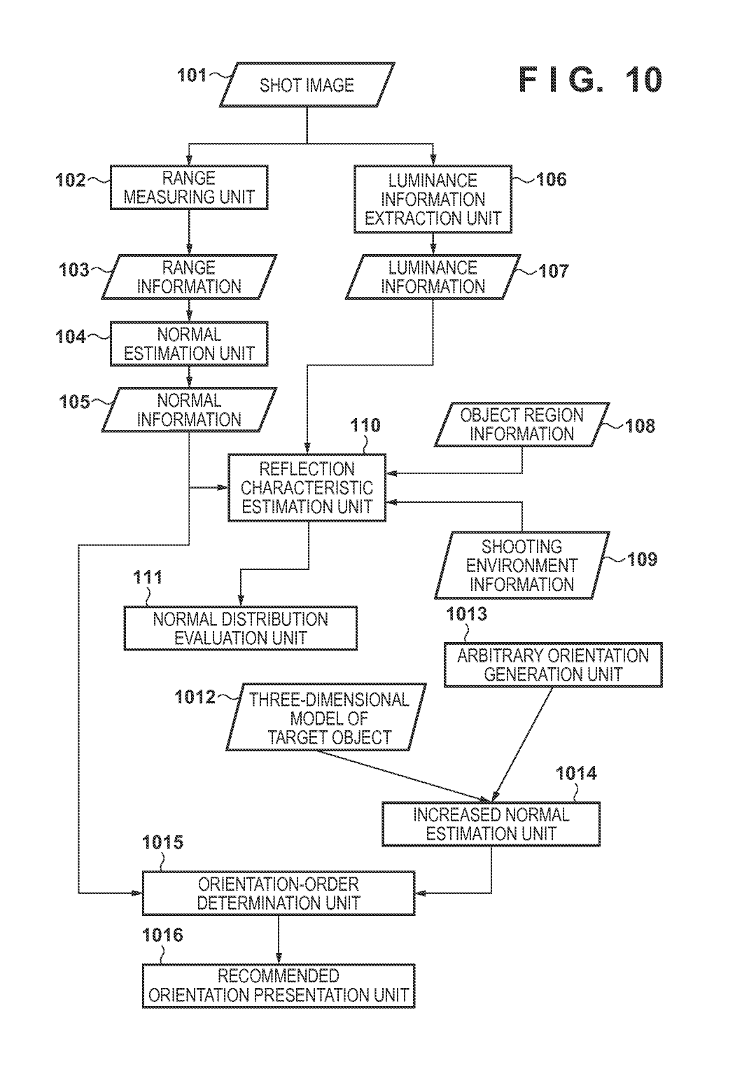

In the third embodiment, upon determining that normal line information 105 is insufficient, a normal distribution presentation unit 811 presents a direction in which the normal line information 105 lacks. First, after performing capturing at least once, the normal line information 105 (to be referred to as “observed normal line information” hereinafter) obtained up to that time is three-dimensionally presented. FIG. 9A shows an example of the presentation. In the presentation example of FIG. 9A, each position where a normal has been obtained is indicated by a circle on a hemisphere, and a normal direction is indicated by an arrow. A region (to be referred to as a “normal line lack area” hereinafter) corresponding to directions in which the normal line information 105 lacks is indicated by hatching on the hemisphere.

To obtain the normal line lack area, for example, a region around each normal obtained up to that time is covered with a plane having a predetermined area on the hemisphere. An uncovered region on the hemisphere is obtained as the normal line lack area. Note that the angle to display the hemisphere is preferably freely settable by the user. In that case, coordinates serving as the base of world coordinates, robot coordinates, or the like are preferably displayed together.

The presentation method of the normal distribution presentation unit 811 is not limited to that shown in FIG. 9A. For example, an example of presentation shown in FIG. 9B is also considerable. FIG. 9B is a view illustrating the hemisphere expression of FIG. 9A viewed from the upper side of the z-axis (side where a value Z is large). The normal line information 105 is indicated by a circle and an arrow, as in FIG. 9A. Note that since FIGS. 9A and 9B show presentation examples based on different observation point data, the normal line information amounts are different.

Assuming that in the capturing environment shown in FIG. 3, illumination 303 and a camera 304 are located above sufficiently apart from a target object 301 (in a place where the value along the z-axis is sufficient large), a reflection central axis vector \vec{H} can be approximated to the z-axis. In this case, luminance distribution parameters (θ, α, β) in equation (3) to (9) have almost the same value concerning a normal on a circle about the z-axis, as shown in FIG. 9B. Hence, under this condition, since normals on a circle about the z-axis when the hemisphere is viewed from the upper side can be regarded as the same group, a plurality of normal groups are preferably arranged concentrically at predetermined distances from the z-axis. Hence, a normal line lack area is presented as a concentric belt region, like the hatched region shown in FIG. 9B. By referring to the display in FIG. 9B, the user gives consideration to the arrangement of the target object at the time of additional capturing so that many normals in the normal direction distribution of the target object are included in the belt region.

As described above, when the normal line information included in the captured image is insufficient, and the user is prompted to do additional capturing, an effective target object arrangement method is proposed, thereby allowing the user to perform efficient additional capturing.

### Fourth Embodiment

A functional arrangement for implementing reflection characteristic estimation processing according to the fourth embodiment of the present invention, which is implemented by the arrangement shown in FIG. 2, will be described below. FIG. 10 is a block diagram showing the functional arrangement of an information processing apparatus that executes reflection characteristic estimation processing according to the fourth embodiment. Note that the same reference numerals as in FIG. 1 described above denote the same parts in FIG. 10, and a description thereof will be omitted. In the fourth embodiment, a method of proposing a target object arrangement at the time of additional capturing will be described, as in the third embodiment.

In the fourth embodiment, upon determining that normal line information 105 is insufficient, a scene where the target object is virtually arranged in various orientations is reproduced, and normal line information observed in each orientation is calculated. The degree of improvement of the sufficiency of normal line information when the virtually calculated normal line information is added to the observed normal line information 105 is evaluated for each orientation.

For each orientation of the target object generated by an arbitrary orientation generation unit 1013, an increased normal estimation unit 1014 estimates normal line information (to be referred to as “increased normal line information” hereinafter) newly obtained by observing the target object using a three-dimensional model 1012 of the target object. An orientation-order determination unit 1015 merges the increased normal line information for each orientation estimated by the increased normal estimation unit 1014 to the observed normal line information 105, calculates the evaluation value for each orientation, and determines the priority order of each orientation. A recommended orientation presentation unit 1016 presents the orientation of the target object at the time of additional capturing in accordance with the priority order.

[Determination and Presentation of Recommended Orientation]

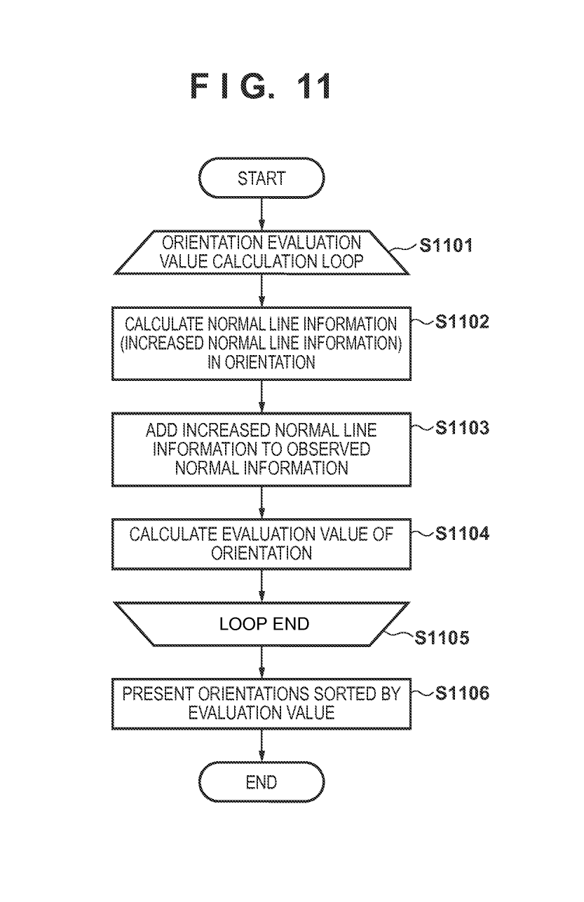

Processing of determining and presenting a recommended orientation by the increased normal estimation unit 1014, the orientation-order determination unit 1015, and the recommended orientation presentation unit 1016 will be described below with reference to the flowchart of FIG. 11.

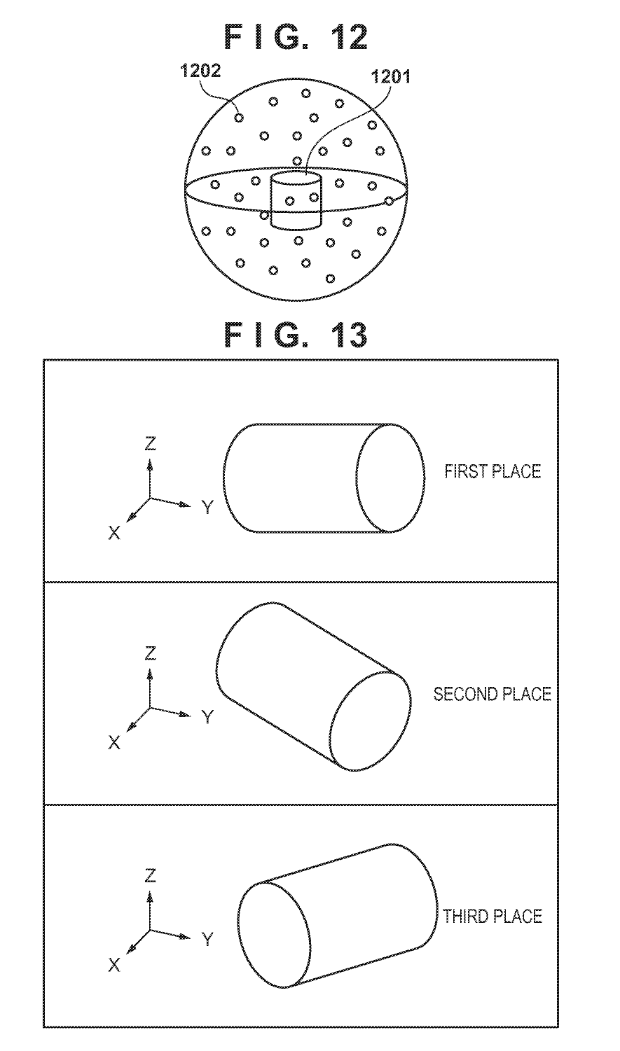

Orientation evaluation value calculation loop processing of calculating an evaluation value for each orientation is performed between steps S1101 and S1105. First, the increased normal estimation unit 1014 calculates normal line information (increased normal line information) at a point on the surface of a target object 1201 for each orientation of the target object 1201 (S1102). Note that the appearances of various orientations can be implemented by virtually moving the camera 304 for each point of view. FIG. 12 shows an example of orientation setting. Referring to FIG. 12, circles 1202 around the target object 1201 indicate various points of view on a geodesic sphere about the target object 1201. In the fourth embodiment, as the various orientations of the target object 1201, three-dimensional information obtained when virtually observing the target object 1201 from the various points 1202 of view is reproduced from the three-dimensional model 1012 of the target object.

Next, the orientation-order determination unit 1015 adds the increased normal line information calculated in step S1102 to the observed normal line information 105 (S1103). The evaluation values of the sufficiency of the normal line information before and after the addition of the increased normal line information are calculated, and the difference between them is obtained as the evaluation value of the orientation (S1104). As the normal line information sufficiency evaluation algorithm, the same evaluation as that of the normal distribution evaluation unit 111 or 612 according to the first or second embodiment is performed. The evaluation value calculated by the orientation-order determination unit 1015 represents the degree of improvement of the sufficiency of the normal line information, in other words, the degree of improvement toward a state (even distribution without localization) in which an excellent normal direction distribution state is obtained within the range of normal directions (between the minimum value of θ and the maximum value of θ).

At the point of time the orientation evaluation value calculation loop ends (S1105), the evaluation value for each orientation has been calculated. The recommended orientation presentation unit 1016 sorts the plurality of orientations of the target object 1201, whose evaluation values are calculated, in descending order of evaluation values, and presents the result to the user (S1106). FIG. 13 shows an example of presentation. In the example of FIG. 13, recommended orientations in which the target object 1201 is to be arranged at the time of capturing are displayed in accordance with the priority order. At this time, coordinate axes serving as the base of world coordinates, robot coordinates, or the like are preferably presented together to distinctly display the orientations.

As described above, the recommended orientation of the target object is proposed as the effective target object arrangement method at the time of additional capturing, thereby allowing the user to perform efficient additional capturing.

### Other Embodiment

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-270130 filed Dec. 26, 2013 which is hereby incorporated by reference herein in their entirety.

What is claimed is:

1. An information processing apparatus comprising:
an acquisition unit configured to acquire, from an image of an object, luminance information of the object and information representing a three-dimensional shape of the object;
a first estimation unit configured to estimate normal line information on a surface of the object from the information representing the three-dimensional shape, the normal line information representing a normal direction of the surface of the object;
a second estimation unit configured to estimate a reflection characteristic of the object based on a correspondence between the luminance information and normal directions represented by the normal line information; and
an evaluation unit configured to evaluate whether a distribution of the normal directions represented by the normal line information is sufficient for estimation of the reflection characteristic,
wherein at least one of the acquisition unit, the first or second estimation unit, or the evaluation unit is implemented using a processor.

2. The apparatus according to claim 1, wherein the evaluation unit determines based on a result of the evaluation whether or not additional capturing of the object is necessary.

3. The apparatus according to claim 2, wherein the evaluation unit determines based on a difference between the normal directions represented by the normal line information whether or not the additional capturing is necessary.

4. The apparatus according to claim 3, wherein in a case where all differences between the normal directions are not more than a predetermined threshold, the evaluation unit determines that the additional capturing is unnecessary.

5. The apparatus according to claim 2, wherein the evaluation unit sets a tolerance for an error with respect to the estimated reflection characteristic, and determines based on a count of luminance information within the tolerance whether or not the additional capturing is necessary.

6. The apparatus according to claim 5, wherein in a case where the count is not less than a predetermined threshold, the evaluation unit determines that the additional capturing is unnecessary.

7. The apparatus according to claim 1, wherein the acquisition unit acquires, as the information representing the three-dimensional shape, range information representing a range from a capturing position of the object to a surface of the object contained in the image.

8. The apparatus according to claim 1, wherein the second estimation unit uses capturing environment information of the shot image to estimate the reflection characteristic.

9. The apparatus according to claim 8, wherein the second estimation unit further uses object region information representing an existence region of the object to estimate the reflection characteristic.

10. The apparatus according to claim 1, wherein the image is an image obtained by capturing a plurality of objects of same type in a bulk state.

11. The apparatus according to claim 2, further comprising a presentation unit configured to, in a case where it is determined that the additional capturing is necessary, present a message representing that the additional capturing is necessary.

12. The apparatus according to claim 11, wherein the presentation unit presents an arrangement of the object in the additional capturing.

13. The apparatus according to claim 11, wherein the presentation unit presents the distribution of the normal directions so as to present the normal line information to be acquired in the additional capturing.

14. The apparatus according to claim 11, further comprising:
a third estimation unit configured to estimate the normal line information to be obtained upon capturing the object for each orientation of the object using a three-dimensional model of the object; and
a determination unit configured to calculate a degree of improvement of the distribution of the normal directions for each orientation of the object based on the normal line information estimated by the first estimation unit and the normal line information estimated by the third estimation unit, and determine a priority order of the orientation of the object based on the degree of improvement.

15. The apparatus according to claim 14, wherein the presentation unit presents the orientation of the object in the additional capturing in accordance with the priority order.

16. The apparatus according to claim 1, wherein the second estimation unit estimates the reflection characteristic of the object by approximating the correspondence between the luminance information and the normal directions represented by the normal line information, and a function representing a luminance distribution model.

17. The apparatus according to claim 1, wherein using an average value of the luminance information included in each section of the normal direction, and a median in the normal direction of the section as representative values of the sections, the second estimation unit estimates a curve that connects the representative values of the sections as the reflection characteristic of the object.

18. The apparatus according to claim 2, further comprising a generation unit configured to generate a histogram representing a frequency of the luminance information included in each section of the normal direction.

19. The apparatus according to claim 18, wherein in a case where the frequency is not less than a predetermined number in all sections of the histogram, the evaluation unit determines that the additional capturing is unnecessary.

20. An information processing method comprising:
using a processor to perform steps of:
acquiring, from an image of an object, luminance information of the object and information representing a three-dimensional shape of the object;
estimating normal line information on a surface of the object from the information representing the three-dimensional shape, the normal line information representing a normal direction of the surface of the object;
estimating a reflection characteristic of the object based on a correspondence between the luminance information and normal directions represented by the normal line information; and
evaluating whether a distribution of the normal directions represented by the normal line information is sufficient for estimation of the reflection characteristic.

21. A non-transitory computer readable medium storing a computer-executable program for causing a computer to perform an information processing method, the method comprising steps of:
acquiring, from an image of an object, luminance information of the object and information representing a three-dimensional shape of the object;
estimating normal line information on a surface of the object from the information representing the three-dimensional shape, the normal line information representing a normal direction of the surface of the object;
estimating a reflection characteristic of the object based on a correspondence between the luminance information and normal directions represented by the normal line information; and
evaluating whether a distribution of the normal directions represented by the normal line information is sufficient for estimation of the reflection characteristic.
